(19) United States
(12) Patent Application Publication
(10) Pub. No.: US 2022/0111855 A1
(43) Pub. Date: Apr. 14, 2022

(54) AGENT DEVICE, AGENT METHOD AND STORAGE MEDIUM STORING AGENT PROGRAM

(71) Applicant: TOYOTA JIDOSHA KABUSHIKI KAISHA, Toyota-shi, (JP)

(72) Inventors: Eiichi MAEDA, Tokyo (JP); Keiko NAKANO, Kawasaki-shi (JP); Chikage KUBO, Tokyo (JP); Hiroyuki NISHIZAWA, Nagakute-shi (JP)

(73) Assignee: TOYOTA JIDOSHA KABUSHIKI KAISHA, Toyota-shi (JP)

(21) Appl. No.: 17/468,259

(22) Filed: Sep. 7, 2021

(30) Foreign Application Priority Data
Oct. 9, 2020 (JP) 2020-171496

(51) Int. Cl. B60W 50/10; B60W 40/09; G06K 9/00

(52) U.S. Cl. CPC B60W 50/10; B60W 2554/4045; G06K 9/00845; B60W 40/09

(57) ABSTRACT

An agent device executes processing including receiving words and actions from an occupant of a vehicle, identifying an intention of the received words and actions, selecting, as a recommended function, a function of the vehicle that is recommended for activation based on the identified intention of the vehicle occupant, deciding which of activating the selected recommended function, or suggesting the activation thereof, to execute based on predetermined conditions pertaining to an environment of the vehicle, and instructing the vehicle either to activate the recommended function or to suggest the activation thereof based on the decision.

### CROSS-REFERENCE TO RELATED APPLICATION

This application is based on and claims priority under 35 USC 119 from Japanese Patent Application No. 2020-171496 filed on Oct. 9, 2020, the disclosure of which is incorporated by reference herein.

### BACKGROUND

### Technical Field

The present disclosure relates to an agent device, an agent method, and a storage medium storing an agent program used to activate functions pertaining to a vehicle or to suggest an activation thereof.

### Related Art

An agent processing device for a vehicle that supplies information relating to operations of various types of vehicle on-board units is disclosed in Japanese Unexamined Patent Application Laid-Open (JP-A) No. 2001-141500.

The agent processing device for a vehicle disclosed in JP-A 2001-141500 is formed such that, when prompted by an utterance made by a driver, the agent processing device proposes a method of activating functions with which a vehicle is equipped in accordance with the contents of this utterance.

In order, however, to utilize a proposed function, it is necessary for the driver either to repeat their utterance so as to activate the function, or to directly operate an operating portion so as to activate the function. For this reason, there is room for improvement from the standpoint of lightening the burden of performing such operations on the driver.

### SUMMARY

It is an object of the present disclosure to provide an agent device, and agent method, and a storage medium storing an agent program that, by causing functions of a vehicle to be activated in accordance with the words and actions of a vehicle occupant and with an environment of the vehicle, make it possible to achieve a lightening of the burden of performing such operations on the vehicle occupant.

A first aspect is an agent device provided with a receiving portion that receives words and actions from an occupant of a vehicle, an intention identification portion that identifies an intention of the words and actions received by the receiving portion, a selecting portion that, based on the intention of the vehicle occupant as identified by the intention identification portion, selects, as a recommended function, a function of the vehicle that is recommended for activation, a deciding portion that, based on predetermined conditions pertaining to an environment of the vehicle, makes a decision as to which of activating the recommended function selected by the selecting portion or suggesting the activation thereof, to execute, and an instructing portion that, based on a decision made by the deciding portion, instructs the vehicle either to activate the recommended function or to suggest the activation thereof.

In the agent device of the first aspect, when the receiving portion receive words or an action from a vehicle occupant, the intention identification portion identify the received words or actions. The selecting portion then select a recommended function in the vehicle based on the identified intention of the vehicle occupant. This ‘recommended function’ refers to a function, out of the functions of the vehicle, whose activation is recommended to a vehicle occupant. The recommended function may be selected from all functions such as travel functions, safety functions, and comfort functions and the like. Moreover, in this agent device, when the deciding portion decide, based on predetermined conditions pertaining to the vehicle environment, which of activating the recommended function selected by the selecting portion, or suggesting the activation thereof, to execute, the instructing portion instruct the vehicle either to activate the recommended function or to suggest the activation thereof, to execute. Here, the ‘predetermined conditions pertaining to the vehicle environment’ refer to the state of the weather in the geographical location at which the vehicle is traveling, the position of the vehicle, and the travel state of the vehicle.

In a case in which the instruction is an instruction that pertains to activating the recommended function, a device on the vehicle side that receives this instruction causes the recommended function to be activated. As a result, according to this agent device, by causing a vehicle function to be activated in accordance with the words and actions of a vehicle occupant and with the environment of the vehicle, it is possible to achieve a lightening of the burden of performing such operations on the vehicle occupant.

An agent device of a second aspect is characterized in that, in the agent device of the first aspect, the receiving portion receives information regarding acquired images of the vehicle occupant that are acquired by an image acquisition device installed in the vehicle, and the intention identification portion identifies the intention of the vehicle occupant based on at least one of a facial expression or a movement of the vehicle occupant.

In the agent device of the second aspect, in addition to words and actions, the intention identification portion also identifies an intention based on at least one of a facial expression or a movement of the vehicle occupant. According to this agent device, by causing functions to be activated based on the facial expression or movement of a vehicle occupant, it is possible to further lighten the burden of performing an operation on the vehicle occupant.

An agent device of a third aspect is characterized in that, in the agent device of the first or second aspects, there is further provided a weather acquisition portion that acquires weather information relating to weather in a geographical location at which the vehicle is traveling, and the deciding portion decides which of activating the recommended function, or suggesting the activation thereof, to execute, with a state of the weather as shown by the weather information acquired by the weather acquisition portion set as a predetermined condition.

In the agent device of the third aspect, the deciding portion decides which of activating the recommended function or suggesting the activation thereof, to execute based on the state of the weather as shown by the weather information acquired by the weather acquisition portion. According to this agent device, by utilizing a state of the weather when deciding whether or not to activate a recommended function, it is possible to decide whether or not to activate a recommended function while complementing the intention of the vehicle occupant.

An agent device of a fourth aspect is characterized in that, in the agent device of the third aspect, in a case in which the recommended function is a function that is associated with the state of the weather, the deciding portion decides that the recommended function is to be activated, and in a case in which the recommended function is a function that is not associated with the state of the weather, the deciding portion decides that activation of the recommended function is to be suggested.

In the agent device of the fourth aspect, in a case in which the recommended function is a function that corresponds to the state of the weather in the geographical location at which the vehicle is traveling, the deciding portion decides that the recommended function is to be activated, and in a case in which the recommended function is a function that does not correspond to the state of the weather in the geographical location at which the vehicle is traveling, the deciding portion decides that activation of the recommended function is to be suggested. According to this agent device, it is possible to inhibit a recommended function from being activated when the state of the weather is not conducive to the recommended function being activated.

An agent device of a fifth aspect is characterized in that, in the agent device of any one of the first through fourth aspects, there is further provided a position acquisition portion that acquires position information for the vehicle, and the deciding portion decides which of activating the recommended function, or suggesting the activation thereof, to execute, with a position of the vehicle that corresponds to the position information acquired by the position acquisition portion set as a predetermined condition.

In the agent device of the fifth aspect, the deciding portion decides which of activating the recommended function or suggesting the activation thereof, to execute, based on a position of the vehicle that corresponds to the position information acquired by the position acquisition portion. According to this agent device, by utilizing a position of the vehicle when deciding whether or not to activate a recommended function, it is possible to decide whether or not to activate a recommended function while complementing the intention of the vehicle occupant.

An agent device of a sixth aspect is characterized in that, in the agent device of the fifth aspect, in a case in which the position is one at which the recommended function is able to be used, the deciding portion decides that the recommended function is to be activated, and in a case in which the position is one at which the recommended function is not able to be used, the deciding portion decides that activation of the recommended function is to be suggested.

In the agent device of the sixth aspect, in a case in which the position is one at which the recommended function is able to be used, the deciding portion decides that the recommended function is to be activated, and in a case in which the position is one at which the recommended function is not able to be used, the deciding portion decides that activation of the recommended function is to be suggested. According to this agent device, it is possible to inhibit a recommended function from being activated when the location where the vehicle is traveling is not conducive to the recommended function being activated.

An agent device of a seventh aspect is characterized in that, in the agent device of any one of the first through sixth aspects, there is further provided a travel acquisition portion that acquires a travel state of the vehicle, and the deciding portion decides which of activating the recommended function, or suggesting the activation thereof, to execute, with the travel state of the vehicle acquired by the travel acquisition portion set as a predetermined condition.

In the agent device of the seventh aspect, the deciding portion decides which of activating the recommended function or suggesting the activation thereof, to execute, based on a travel state of the vehicle acquired by a travel acquisition portion. According to this agent device, by utilizing a travel state of the vehicle when deciding whether or not to activate a recommended function, it is possible to decide whether or not to activate a recommended function while complementing the intention of the vehicle occupant.

An agent device of an eighth aspect is characterized in that, in the agent device of the seventh aspect, in a case in which the vehicle is stopped, the deciding portion decides that the recommended function is to be activated, while in a case in which the vehicle is traveling, the deciding portion decides that activation of the recommended function is to be suggested.

In the agent device of the eighth aspect, the deciding portion decides that the recommended function is to be activated in a case in which the vehicle is stopped, while in a case in which the vehicle is traveling, the deciding portion decides that activation of the recommended function is to be suggested. According to this agent device, by inhibiting the activation of a recommended function that might become an obstruction to travel while a vehicle is traveling, it is possible to improve safety while the vehicle is traveling.

An agent method of a ninth aspect is a method in which a computer executes processing including receiving words and actions from an occupant of a vehicle, identifying an intention of the received words and actions, selecting, as a recommended function, a function of the vehicle that is recommended for activation based on the identified intention of the vehicle occupant, making a decision as to which of activating the selected recommended function, or suggesting the activation thereof, to execute, based on predetermined conditions pertaining to an environment of the vehicle, and instructing the vehicle either to activate the recommended function or to suggest the activation thereof, based on the decision.

In the agent method of the ninth aspect, when a computer receives words or actions from an occupant of a vehicle, the computer identifies the received words or actions. Based on the identified intention of the vehicle occupant, the computer selects a recommended function. Moreover, in this agent method, when the computer decides which of activating the selected recommended function, or suggesting the activation thereof, to execute based on predetermined conditions pertaining to an environment of the vehicle, the computer instructs the vehicle either to activate the recommended function or to suggest the activation thereof. Here, ‘recommended function’ and ‘predetermined conditions pertaining to the vehicle environment’ have the same meanings as are described above. In a case in which the instruction is an instruction that pertains to activating the recommended function, a device on the vehicle side that receives this instruction causes the recommended function to be activated. As a result, according to this agent method, by causing a vehicle function to be activated in accordance with the words and actions of a vehicle occupant and with an environment of the vehicle, it is possible to achieve a lightening of the burden of performing such operations on the vehicle occupant.

A non-transitory storage medium storing an agent program of a tenth aspect causes executable by a computer to perform processing including receiving words and actions from an occupant of a vehicle, identifying an intention of the received words and actions, selecting, as a recommended function, a function of the vehicle that is recommended for activation based on the identified intention of the vehicle occupant, deciding which of activating the selected recommended function, or suggesting the activation thereof, to execute based on predetermined conditions pertaining to an environment of the vehicle, and instructing the vehicle either to activate the recommended function or to suggest the activation thereof, based on which of these the processor has decided to execute.

In the agent program of the tenth aspect, a computer performs the following processing. Namely, when a computer receives words or actions from an occupant of a vehicle, the computer identifies the received words or actions. Based on the identified intention of the vehicle occupant, the computer selects a recommended function. Moreover, in this agent program, when the computer decides which of activating the recommended function or suggesting the activation thereof, to execute, based on predetermined conditions pertaining to an environment of the vehicle, the computer instructs the vehicle either to activate the recommended function or to suggest the activation thereof, to execute. Here, ‘recommended function’ and ‘predetermined conditions pertaining to the vehicle environment’ have the same meanings as are described above. In a case in which the instruction is an instruction that pertains to activating the recommended function, a device on the vehicle side that receives this instruction causes the recommended function to be activated. As a result, according to this agent program, by causing a vehicle function to be activated in accordance with the words and actions of a vehicle occupant and with an environment of the vehicle, it is possible to achieve a lightening of the burden of performing such operations on the vehicle occupant.

According to the present disclosure, by causing a vehicle function to be activated in accordance with the words and actions of a vehicle occupant and with an environment of the vehicle, it is possible to achieve a lightening of the burden of performing such operations on the vehicle occupant.

### BRIEF DESCRIPTION OF THE DRAWINGS

Exemplary embodiments of the present disclosure will be described in detail based on the following figures, wherein:

FIG. 1 is a diagram illustrating a schematic configuration of an agent system according to a first exemplary embodiment;

FIG. 2 is a block diagram illustrating a hardware configuration of a vehicle in the first exemplary embodiment;

FIG. 3 is a block diagram illustrating a hardware configuration of a central server in the first exemplary embodiment;

FIG. 4 is a block diagram illustrating a function configuration of the central server in the first exemplary embodiment.

FIG. 5 is a flowchart illustrating a flow of recommendation processing executed by the central server in the first exemplary embodiment;

FIG. 6 is a flowchart illustrating a flow of providing processing executed by a vehicle on-board unit in the first exemplary embodiment;

FIG. 7A is an example of activities taking place through spoken utterances in the first exemplary embodiment;

FIG. 7B is an example of activities taking place through a monitor in the first exemplary embodiment; and

FIG. 8 is a flowchart illustrating a flow of providing processing executed by a vehicle on-board unit in the second exemplary embodiment.

### DETAILED DESCRIPTION

An agent system that includes an agent device of the present disclosure will now be described.

### First Exemplary Embodiment

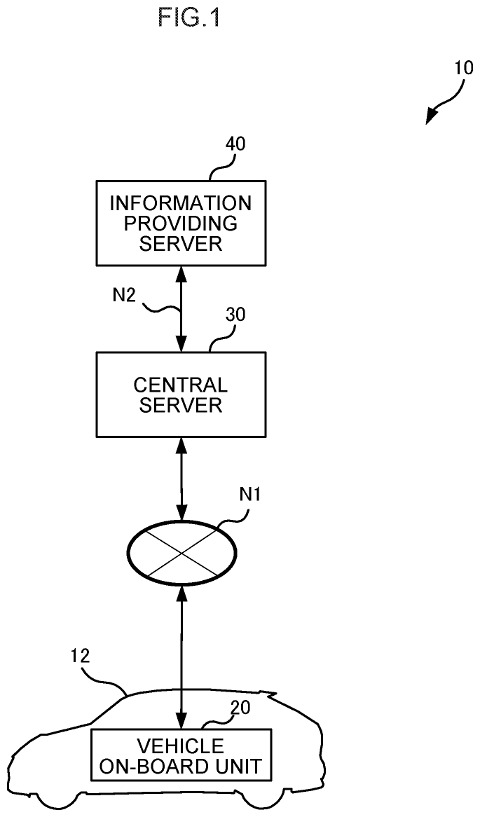

As illustrated in FIG. 1, the agent system 10 according to the first exemplary embodiment is configured including a vehicle 12, a central server 30, serving as an agent device, and an information providing server 40. A vehicle on-board unit 20, serving as a notification device, is installed in the vehicle 12.

The vehicle on-board unit 20 and the central server 30 are connected to each other through a network N1. In addition, the central server 30 and the information providing server 40 are connected to each other through a network N2. Note that the central server 30 and the information providing server 40 may also be connected to each other through the network N1.

Vehicle

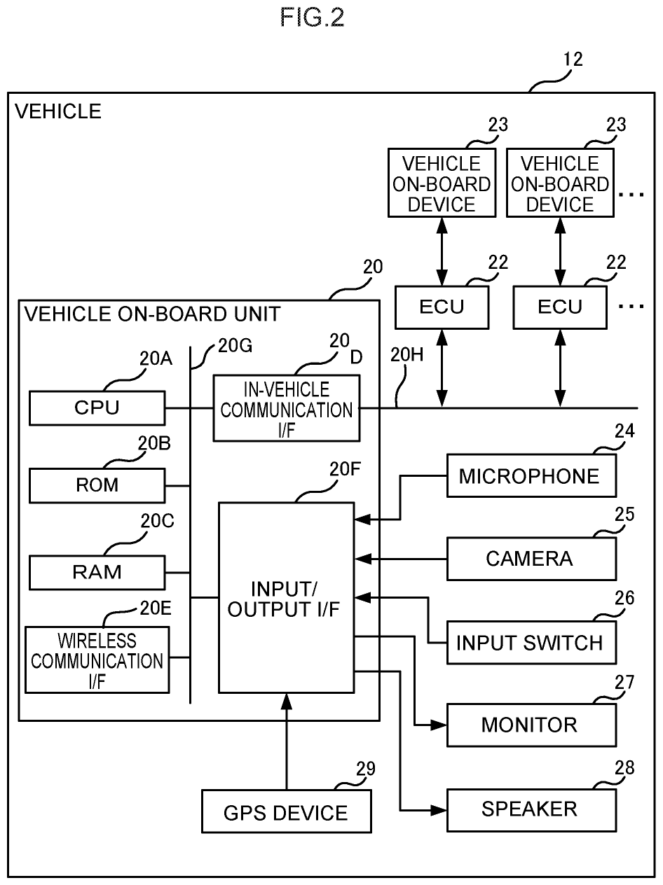

As illustrated in FIG. 2, the vehicle 12 according to the present exemplary embodiment is configured including the vehicle on-board unit 20, a plurality of ECU 22, a plurality of vehicle on-board devices 23, a microphone 24, a camera 25, an input switch 26, a monitor 27, a speaker 28, and a GPS device 29.

The vehicle on-board unit 20 is configured including a central processing unit (CPU) 20A, read only memory (ROM) 20B, random access memory (RAM) 20C, an in-vehicle communication inter face (I/F) 20D, a wireless communication I/F 20E, and an input/output I/F 20F. The CPU 20A, the ROM 20B, the RAM 20C, the in-vehicle communication I/F 20D, the wireless communication I/F 20E, and the input/output I/F 20F are connected together so as to be capable of communicating with each other through an internal bus 20G.

The CPU 20A is a central processing unit that executes various programs and controls various sections. Namely, the CPU 20A reads programs from the ROM 20B, and executes these programs using the RAM 20C as a workspace.

The ROM 20B stores various programs and various data. The ROM 20B of the present exemplary embodiment stores control programs used to control the vehicle on-board unit 20.

The RAM 20C serves as a workspace to temporarily store programs or data.

The in-vehicle communication I/F 20D is an interface for connecting to ECU 22. A communication Standard based on a CAN protocol is employed for this interface. The in-vehicle communication I/F 20D is connected to an external bus 20H. An individual ECU 22 is provided respectively for each function of the vehicle 12. Examples of the ECU 22 of the present exemplary embodiment include a vehicle control ECU, an engine ECU, a brake ECU, a body ECU, a camera ECU, and a multimedia ECU.

In addition, an individual vehicle on-board device 23 is connected to the respective ECU 22. The vehicle on-board devices 23 are devices that enable the functions of the vehicle 12 to be performed. For example, a throttle actuator is connected as a vehicle on-board device 23 to the engine ECU, while a brake actuator is connected as a vehicle on-board device 23 to the brake ECU. Moreover, a lighting device and a wiper device are connected as vehicle on-board devices 23 to the body ECU.

The wireless communication I/F 20E is a wireless communication module used for communicating with the central server 30. For example, 5G, LTE, Wi-Fi (Registered Trademark) or the like is employed as communication standard for this wireless communication module. The wireless communication I/F 20E is connected to the network N1.

The input/output I/F 20F is an interface for communicating with the microphone 24, the camera 25, the input switch 26, the monitor 27, the speaker 28, and the GPS device 29 installed in the vehicle 12.

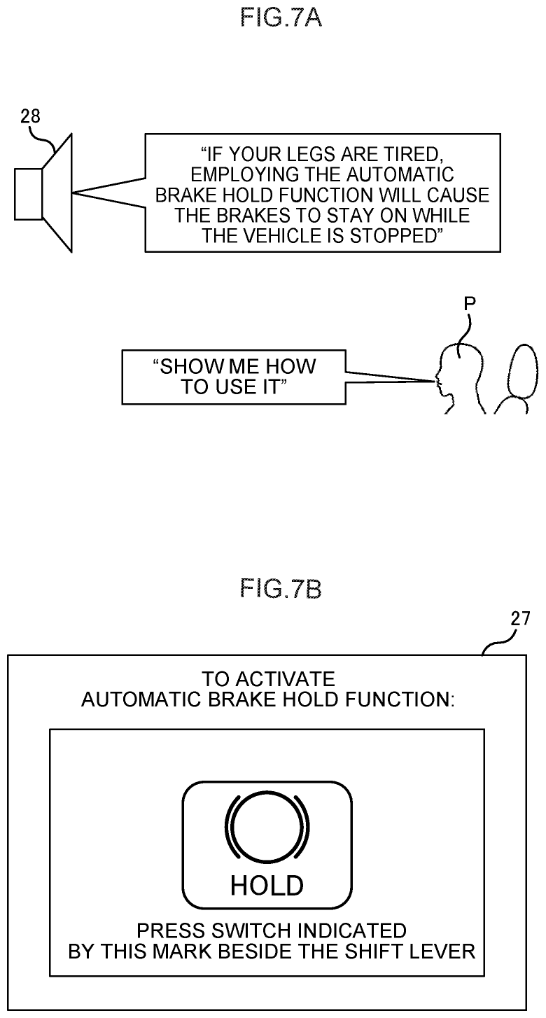

The microphone 24, serving as a voice input device, is provided in a front pillar, or in a dashboard or the like of the vehicle 12, and is a device that picks up voice audio spoken by a user, namely, by an occupant P (see FIG. 7A) of the vehicle 12. Note that the microphone 24 may also be provided in the camera 25 (described below).

The camera 25, serving as an image acquisition device, is provided in the front pillar, rear-view mirror, or steering column or the like of the vehicle 12, and is a device that acquires images of the occupant P of the vehicle 12. Note that the camera 25 may also be connected to the vehicle on-board unit 20 through an ECU 22 (for example, the camera ECU).

The input switch 26 is provided in an instrument panel, a center console, or a steering wheel or the like, and is a switch used by the vehicle occupant P to input operations manually. For example, a push-button numeric keypad, or a touchpad or the like can be employed as the input switch 26.

The monitor 27, serving as a display device, is provided in the instrument panel, or in a meter panel or the like, and is a liquid crystal monitor used to display images suggesting operations pertaining to functions of the vehicle 12, and images pertaining to descriptions of those functions. Note that the monitor 27 may also be provided as a touch panel that additionally functions as the input switch 26.

The speaker 28 is provided in the instrument panel, the center console, a front pillar, or in the dashboard or the like, and is a device used to output audio suggesting operations pertaining to functions of the vehicle 12, and audio pertaining to descriptions of those functions. Note that the speaker 28 may also be provided in the monitor 17.

The GPS device 29 is a device for measuring the current position of the vehicle 12. The GPS device 29 includes an antenna (not shown in the drawings) to receive signals from GPS satellites. Note that the GPS device 29 may also be connected to the vehicle on-board unit 20 through a car navigation system that is connected to an ECU 22 (for example, the multimedia ECU).

Central Server

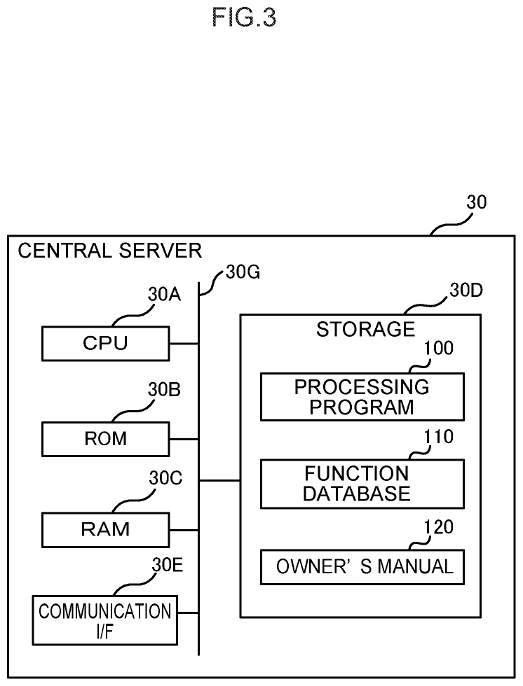

As illustrated in FIG. 3, the central server 30 is configured including a CPU 30A, ROM 30B, RAM 30C, storage 30D, and a communication I/F 30E. The CPU 30A, the ROM 30B, the RAM 30C, the storage 30D, and the communication I/F 30E are connected together so as to be capable of communicating with each other through an internal bus 30G. Functionality of the CPU 30A, the ROM 30B, the RAM 30C, and the communication I/F 30E is substantially the same as that of the CPU 20A, the ROM 20B, the RAM 20C, and the wireless communication I/F 20E of the vehicle on-board unit 20 described above. The CPU 30A is an example of a processor.

The storage 30D is configured by a hard disk drive (HDD) or a solid state drive (SSD), and stores various programs and various data.

The CPU 30A reads programs from the storage 30D, and executes these programs using the RAM 30C as a workspace.

A processing program 100, a function database 110, and an owner's manual 120 are stored in the storage 30D of the present exemplary embodiment. Note that it is also possible for the function database 110 and the owner's manual 120 to be stored in a different server from the central server 30, and for these to be read if the processing of the vehicle on-board unit 20 or the central server 30 has been executed.

The processing program 100, serving as an agent program, is a program that is used to perform the various functions belonging to the central server 30.

The function database 110 is a database in which are collected the functionality of the vehicle 12 in accordance with the vehicle model and grade.

The owner's manual 120 is data for a manual pertaining to the functionality of the vehicle 12. The owner's manual 120 is stored, for example, as HTML format data.

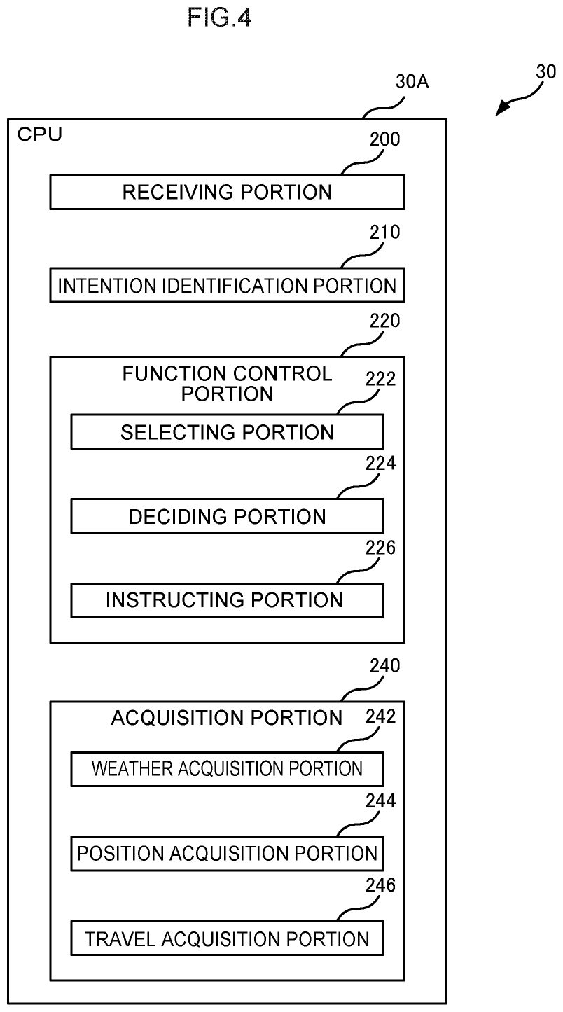

As illustrated in FIG. 4, in the central server 30 of the present exemplary embodiment, the CPU 30A functions as a receiving portion 200, an intention identification portion 210, a function control portion 220, and an acquisition portion 240 by executing the processing program 100. In addition, the function control portion 220 includes a selecting portion 222, a deciding portion 224, and an instructing portion 226, while the acquisition portion 240 includes a weather acquisition portion 242, a position acquisition portion 244, and a travel acquisition portion 246.

The receiving portion 200 has a function of receiving words and actions of the occupant P of the vehicle 12. The receiving portion 200 receives from the vehicle on-board unit 20 audio information that is generated as a result of the vehicle occupant P speaking an utterance towards the microphone 24. In addition, the receiving portion 200 receives from the vehicle on-board unit 200 image information regarding acquired images of the vehicle occupant P acquired by the camera 25.

The intention identification portion 210 has a function of identifying an intention of the words or actions received by the receiving portion 200. The intention identification portion 210 identifies the intention of the vehicle occupant P based on the contents of the utterances spoken by the vehicle occupant P. For example, in a case in which the vehicle occupant P speaks the utterance ‘lower the temperature’, the intention identification portion 210 identifies that this utterance is intended to achieve a lowering of the temperature inside the vehicle cabin. Moreover, in a case in which, for example, after the activation of the ACC (Adaptive Cruise Control) has been suggested to the vehicle occupant P, the vehicle occupant P then speaks the utterance ‘turn on’, the intention identification portion 210 identifies that this utterance has the intention of causing the ACC to be activated.

Moreover, the intention identification portion 210 identifies an intention of the vehicle occupant P based on at least one of a facial expression or a movement of the vehicle occupant P as acquired by the camera 25. For example, the intention identification portion 210 identifies that the vehicle occupant P intends to convey that they are feeling drowsy based on the state of blinking of the eyes of the vehicle occupant P. Moreover, in a case in which, for example, after the activation of the ACC (Adaptive Cruise Control) has been suggested to the vehicle occupant P, the vehicle occupant P then waves their hand from side to side, the intention identification portion 210 identifies that there is no intention to cause the ACC to be operated.

The function control portion 220 has a function of controlling agent functions performed in the vehicle on-board unit 20. Agent functions are not limited to spoken utterances from the speaker 28, and may include images provided by the monitor 27.

The selecting portion 222 has a function of selecting recommended functions for the vehicle 12 based on the intention of the vehicle occupant P as identified by the intention identification portion 210. Here, a recommended function is a function, out of the functions of the vehicle 12, whose activation is recommended to the vehicle occupant P. For example, in a case in which, as is described above, the intention identification portion 210 identifies that the vehicle occupant P intends for the temperature inside the vehicle cabin to be lowered, the selecting portion 222 selects activating the air-conditioner as the recommended function.

The deciding portion 224 has a function of making a decision as to which of activating the recommended function selected by the selecting portion 222, or suggesting the activation thereof, to execute based on predetermined conditions pertaining to an environment of the vehicle 12. The ‘predetermined conditions pertaining to an environment of the vehicle 12’ of the present exemplary embodiment include the state of the weather at the geographical location at which the vehicle 12 is traveling, the position of the vehicle 12, and the travel state of the vehicle 12.

In a case in which the predetermined conditions are taken as being the state of the weather as shown by the weather information acquired by the weather acquisition portion 242 (described below), then in a case in which the recommended function is a function that is associated with the current state of the weather, the deciding portion 224 decides that the recommended function is to be activated, and in a case in which the recommended function is a function that is not associated with the current state of the weather, the deciding portion 224 decides that activation of the recommended function is to be suggested. For example, in a case in which the selecting portion 222 has selected activating the windscreen wipers as the recommended function, then if the state of the weather is rain, the deciding portion 224 decides that the function is to be activated, while if the state of the weather is cloudy, the deciding portion 224 decides that activating the function is to be suggested.

Furthermore, in a case in which the predetermined conditions are taken as being the position of the vehicle 12 as shown by the position information acquired by the position acquisition portion 244 (described below), then in a case in which the position of the vehicle 12 is a position at which the recommended function is able to be used, the deciding portion 224 decides that the recommended function is to be activated, while in a case in which the position of the vehicle 12 is a position at which the recommended function is not able to be used, the deciding portion 224 decides that activation of the recommended function is to be suggested. For example, in a case in which the selecting portion 222 has selected activating the ACC as the recommended function, then if the position of the vehicle 12 is on an expressway, the deciding portion 224 decides that the function is to be activated, while if the position of the vehicle 12 is on a road in a suburban area, the deciding portion 224 decides that activation of the recommended function is to be suggested.

Moreover, in a case in which the predetermined conditions are taken as being the travel state of the vehicle 12 as acquired by the travel acquisition portion 246 (described below), then in a case in which the vehicle 12 is stopped, the deciding portion 224 decides that the recommended function is to be activated, while in a case in which the vehicle 12 is traveling, the deciding portion 224 decides that activation of the recommended function is to be suggested. For example, in a case in which the selecting portion 222 has selected playing a video as the recommended function, then if the vehicle 12 is stopped, the deciding portion 224 decides that the video is to be played, while if the vehicle 12 is traveling, the deciding portion 224 decides that playing the video is to be suggested.

The instructing portion 226 has a function of providing an instruction to activate a recommended function or to suggest the activation thereof as a command to the vehicle 12 based on the decision made by the deciding portion 224.

The acquisition portion 240 has a function of acquiring information pertaining to the peripheral environment of the vehicle 12 and information pertaining to the vehicle 12 itself.

The weather acquisition portion 242 has a function of acquiring weather information relating to the weather at the geographical location at which the vehicle 12 is traveling. More specifically, the weather acquisition portion 242 acquires from the information providing server 40 weather information relating to the weather at the geographical location at which the vehicle 12 is traveling. This weather information includes not only the local weather conditions, but also various types of information pertaining to the weather such as the temperature, humidity, rainfall, sunshine, and the ultraviolet light intensity and the like.

The position acquisition portion 244 has a function of acquiring position information for the vehicle 12. More specifically, the position acquisition portion 244 acquires from the vehicle on-board unit 20 position information for the vehicle 12 acquired by the GPS device 29.

The travel acquisition portion 246 has a function of acquiring a travel state of the vehicle 12. More specifically, the travel acquisition portion 246 acquires from the vehicle on-board unit 20 vehicle speed information held by an ECU 22 such as the vehicle control ECU or the like.

Control Flow

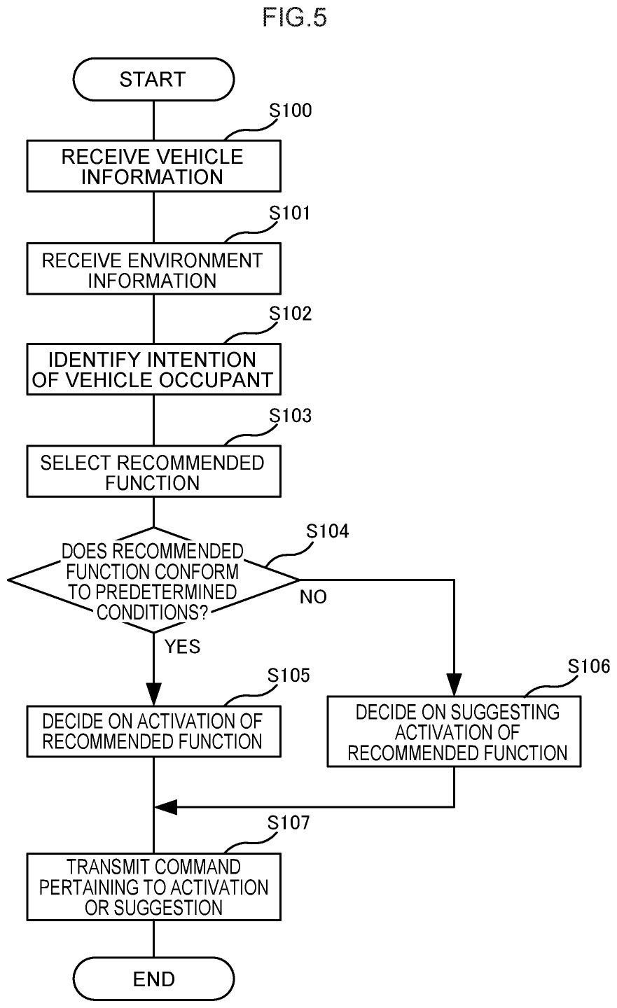

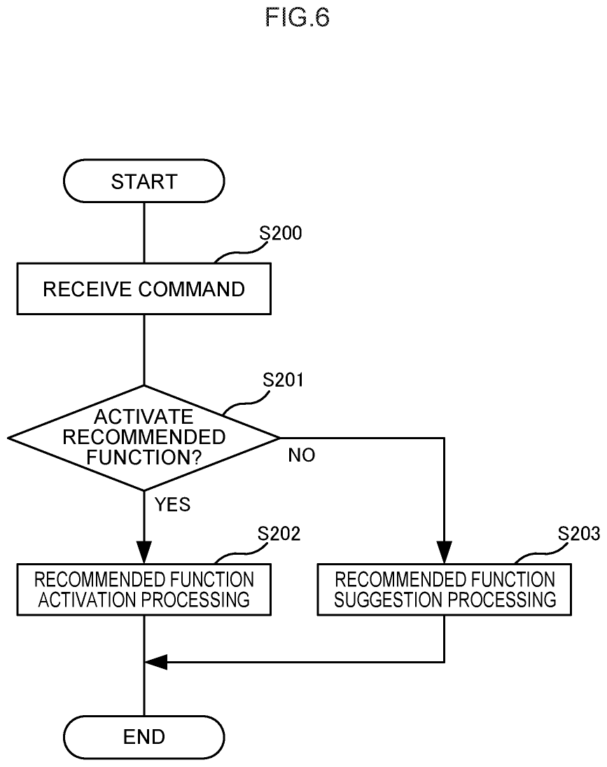

A flow of processing executed by the agent system 10 of the present exemplary embodiment will now be described using the flowcharts shown in FIG. 5 and FIG. 6.

Firstly, in the vehicle 12, in a case in which an utterance made by the vehicle occupant P is picked up by the microphone 24, audio information is transmitted from the vehicle on-board unit 20 to the central server 30. Moreover, in a case in which the vehicle on-board unit 20 determines that some kind of intention is contained in an acquisition image of the vehicle occupant P acquired by the camera 25, image information is also transmitted from the vehicle on-board unit 20 to the central server 30. In addition, at least position information for the vehicle 12 and vehicle speed information for the vehicle 12 are transmitted from the vehicle on-board unit 20 to the central server 30.

Once the central server 30 receives information from the vehicle on-board unit 20, the recommendation processing shown in FIG. 5 is executed by the central server 30. The processing shown in FIG. 5 is achieved as a result of the CPU 30A functioning as the receiving portion 200, the intention identification portion 210, the function control portion 220, and the acquisition portion 240.

In step S100 shown in FIG. 5, the CPU 30A of the central server 30 receives vehicle information from the vehicle on-board unit 20. This vehicle information includes at least the above-described audio information, image information, position information, and vehicle speed information.

In step S101, the CPU 30A receives environment information from the information providing server 40. This environment information includes at least weather information.

In step S102, the CPU 30A identifies the intention of the vehicle occupant P. More specifically, the CPU 30A identifies the intention of the vehicle occupant P based on audio information pertaining to utterances made by the vehicle occupant P, and image information pertaining to facial expressions and movements of the vehicle occupant P. To describe this more fully, the intention of the vehicle occupant P is obtained as a result of the audio information and image information acquired in step S100 being input into a learned model obtained by performing machine learning using, as teaching data, audio information and image information whose intentions have already been identified.

In step S103, the CPU 30A selects a recommended function. In other words, the CPU 30A selects, as a recommended function, a function of the vehicle 12 that conforms to the intention of the vehicle occupant P.

In step S104, the CPU 30A determines whether or not the recommended function conforms to the predetermined conditions pertaining to an environment of the vehicle 12. As is described above, in a case in which the state of the weather at the geographical location at which the vehicle 12 is traveling is set as a predetermined condition, then the CPU 30A determines whether or not the recommended function is a function that is associated with the state of the weather at the geographical location at which the vehicle 12 is traveling. Additionally, in a case in which the position of the vehicle 12 is set as a predetermined condition, then the CPU 30A determines whether or not the position of the vehicle 12 is a position at which the recommended function is able to be used. Furthermore, in a case in which the travel state of the vehicle 12 is set as a predetermined condition, then the CPU 30A determines whether or not the vehicle 12 is stopped. In a case in which the CPU 30A determines that the recommended function does conform to the predetermined conditions (i.e., if the result of the determination in step S104 is YES), then the routine proceeds to step S105. However, in a case in which the CPU 30A determines that the recommended function does not conform to the predetermined conditions (i.e., if the result of the determination in step S104 is NO), then the routine proceeds to step S106.

In step S105, the CPU 30A decides that the recommended function is to be activated.

In step S106, the CPU 30A decides that activation of the recommended function is to be suggested.

In step S107, the CPU 30A transmits a command pertaining to the activation or the suggestion of the recommended function to the vehicle on-board unit 20. The recommendation processing is then ended.

Once the vehicle on-board unit 20 receives the command from the central server 30, the providing processing shown in FIG. 6 is executed by the vehicle on-board unit 20. The processing shown in FIG. 6 is achieved as a result of the CPU 20A executing a control program stored in the ROM 20B.

In step S200 shown in FIG. 6, the CPU 20A receives from the central server 30 a command pertaining to the activation or the suggestion of the recommended function.

In step S201, the CPU 20A determines whether or not the received command is for the activation of the recommended function. In a case in which the CPU 20A determines that the received command is for the activation of the recommended function (i.e., if the result of the determination in step S201 is YES), then the routine proceeds to step S202. However, in a case in which the CPU 20A determines that the received command is not for the activation of the recommended function, in other words, in a case in which the CPU 20A determines that the received command is for the suggestion of the recommended function (i.e., if the result of the determination in step S201 is NO), then the routine proceeds to step S203.

In step S202, the CPU 20A executes activation processing for the recommended function. In other words, the CPU 20A causes the vehicle on-board device 23 that pertains to the recommended function to be activated through the ECU 22 that pertains to the recommended function. The providing processing is then ended.

In step S203, the CPU 20A executes suggestion processing for the recommended function. In other words, the CPU 20A suggests the activation of the recommended function to the vehicle occupant P through the monitor 27 and the speaker 28. The providing processing is then ended.

An example of the actions that accompany the execution of the recommendation processing performed by the central server 30, and the providing processing performed by the vehicle on-board unit 20 will now be described using FIG. 7A and FIG. 7B.

For example, in a case in which, based on the vehicle speed information, the vehicle 12 is caught in a traffic jam, and based on the image information, an intention of driver fatigue is acquired for the vehicle occupant P, in the central server 30, an automatic brake hold function is selected as the recommended function. In a case in which the vehicle 12 is traveling, then the suggestion of activating the automatic brake hold function is selected and a command pertaining to this suggestion is transmitted to the vehicle on-board unit 20. In a case in which the vehicle 12 is stopped, then the activation of the automatic brake hold function is selected, and a command pertaining to activation is transmitted to the vehicle on-board unit 20.

Once the vehicle on-board unit 20 receives the command, a suggestion that the automatic brake hold function be activated is made to the vehicle occupant P through the speaker 28. More specifically, as illustrated in FIG. 7A, spoken audio such as “If your legs feel tired, employing the automatic brake hold function will cause the brakes to stay on while the vehicle is stopped” is output from the speaker 28.

If, in response to this, the vehicle occupant P speaks the phrase “Show me how to use it”, the CPU 30A of the central server 30 refers to the function database 110 and the owner's manual 120, and transmits the portion of the manual pertaining to the automatic brake hold function to the vehicle on-board unit 20.

When the vehicle on-board unit 20 receives this portion of the manual, as illustrated in FIG. 7B, the vehicle on-board unit 20 presents a description of the method of activating the automatic brake hold function to the vehicle occupant P through the monitor 27.

### Summary First Exemplary Embodiment

In the central server 30 of the present exemplary embodiment, when the receiving portion 200 receives words or an action from the vehicle occupant P, the intention identification portion 210 identifies the received words or the action. Next, in the function control portion 220, the selection portion 222 selects a recommended function based on the identified intention of the vehicle occupant P, and the deciding portion 224 decides which of activating the recommended function, or suggesting the activation of the recommended function to execute based on predetermined conditions pertaining to an environment of the vehicle 12. Next, in the function control portion 220, the instructing portion 226 transmits an instruction to activate the recommended function or to suggest activating the recommended function to the vehicle on-board unit 20 as a command. When the vehicle on-board unit 20 receives this command, if the command is an instruction pertaining to the activation of the recommended function, then the vehicle on-board unit 20 causes the recommended function to be activated. As a result, according to the central server 30 of the present exemplary embodiment, by causing functions of the vehicle 12 to be activated in accordance with the words or actions of the vehicle occupant P and an environment of the vehicle 12, it is possible to achieve a lightening of the burden on the vehicle occupant P of performing this operation.

Moreover, in the central server 30 of the present exemplary embodiment, the intention identification portion 210 identifies an intention based on at least one of the facial expression or movements of the vehicle occupant P in addition to their spoken utterances. Because of this, according to the present exemplary embodiment, by causing a function to be activated based on a facial expression or movements of the vehicle occupant P, it is possible to further lighten the burden on the vehicle occupant P of performing an operation.

Furthermore, in the central server 30 of the present exemplary embodiment, the deciding portion 224 takes the state of the weather as shown by weather information acquired by the weather acquisition portion 242 as the ‘predetermined condition pertaining to an environment of the vehicle 12’, and then decides whether to activate a recommended function or to suggest the activation thereof, based on this state of the weather. According to the present exemplary embodiment, by using the state of the weather when deciding whether or not to activate a recommended function, it is possible to decide whether or not to activate a recommended function while complementing the intention of the vehicle occupant P.

More specifically, in a case in which the recommended function is a function that is associated with the state of the weather at the geographical location at which the vehicle 12 is traveling, the deciding portion 224 decides that the recommended function is to be activated, and in a case in which the recommended function is a function that is not associated with the state of the weather at the geographical location at which the vehicle 12 is traveling, the deciding portion 224 decides that activation of the recommended function is to be suggested. According to the present exemplary embodiment, it is possible to inhibit a recommended function from being activated when weather conditions are not appropriate for activating that function, for example, it is possible to inhibit the windscreen wipers from being activated when the weather is not rainy but is only cloudy.

Moreover, in the central server 30 of the present exemplary embodiment, the deciding portion 224 takes the position of the vehicle 12 that corresponds to position information acquired by the position acquisition portion 244 as the ‘predetermined condition pertaining to an environment of the vehicle 12’, and then decides whether to activate a recommended function or to suggest the activation thereof, based on this position of the vehicle 12. According to the present exemplary embodiment, by using the position of the vehicle 12 when deciding whether or not to activate a recommended function, it is possible to decide whether or not to activate a recommended function while complementing the intention of the vehicle occupant P.

More specifically, in the case of a position where using the recommended function is possible, the deciding portion 224 decides that the recommended function is to be activated, while in the case of a position where using the recommended function is not possible, the deciding portion 224 decides that activation of the recommended function is to be suggested. According to the present exemplary embodiment, it is possible to inhibit a recommended function from being activated when the travel location is not appropriate for activating that function, for example, it is possible to inhibit the ACC from being activated when the location of the vehicle 12 is on a road in a suburban area.

Furthermore, in the central server 30 of the present exemplary embodiment, the deciding portion 224 takes the travel state of the vehicle 12 acquired by the travel acquisition portion 246 as the ‘predetermined condition pertaining to an environment of the vehicle 12’, and then decides whether to activate a recommended function or to suggest the activation thereof, based on this travel state of the vehicle 12. According to the present exemplary embodiment, by using the travel state of the vehicle 12 when deciding whether or not to activate a recommended function, it is possible to decide whether or not to activate a recommended function while complementing the intention of the vehicle occupant P.

More specifically, in a case in which the vehicle 12 is stopped, the deciding portion 224 decides that the recommended function is to be activated, while in a case in which the vehicle 12 is traveling, the deciding portion decides that activation of the recommended function is to be suggested. According to the present exemplary embodiment, by inhibiting a movie from being played when this is the recommended function, it is possible to improve safety while the vehicle is traveling.

Note that, in the present exemplary embodiment, the state of the weather, the position of the vehicle 12, and the travel state of the vehicle 12 are taken as the ‘predetermined conditions pertaining to an environment of the vehicle 12’, however, the present disclosure is not limited to this, and it is also possible for the travel time of the vehicle 12, or the brightness outside the vehicle 12 or the like to be added to these conditions. In addition, in the decision of whether to activate a recommended function or to suggest this activation, either each condition may be considered individually, or a combination of conditions may be considered.

### Second Exemplary Embodiment

In the first exemplary embodiment, in a case in which the vehicle on-board unit 20 receives a command pertaining to the activation of a recommended function, this recommended function is activated, however, in the second exemplary embodiment, in a case in which a command pertaining to the activation of a recommended function is received, confirmation as to whether or not to activate the recommended function is obtained from the vehicle occupant P. Hereinafter, points of variance from the first exemplary embodiment will be described. Note that because the hardware configuration is the same as in the first exemplary embodiment, a description thereof is omitted.

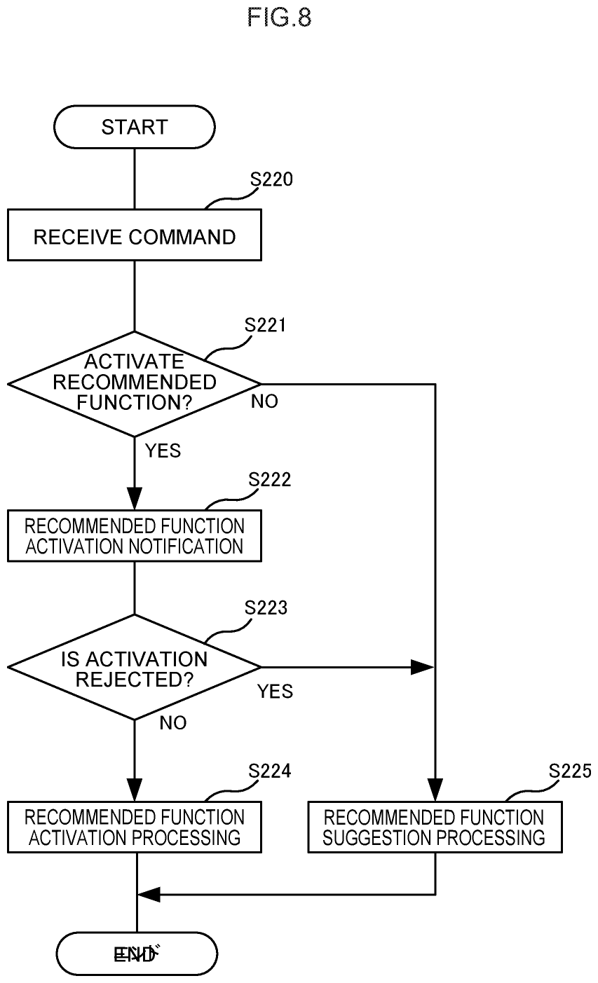

A flow of providing processing executed by the vehicle on-board unit 20 of the present exemplary embodiment will now be described using FIG. 8.

In step S220 shown in FIG. 8, the CPU 20A receives from the central server 30 a command pertaining to the activation or the suggestion of a recommended function.

In step S221, the CPU 20A determines whether or not the received command is for the activation of the recommended function. In a case in which the CPU 20A determines that the received command is for the activation of the recommended function (i.e., if the result of the determination in step S221 is YES), then the routine proceeds to step S222. However, in a case in which the CPU 20A determines that the received command is not for the activation of the recommended function, in other words, in a case in which the CPU 20A determines that the received command is for the suggestion of the recommended function (i.e., if the result of the determination in step S221 is NO), then the routine proceeds to step S225.

In step S222, the CPU 20A provides notification about the activation of the recommended function. More specifically, the CPU 20A notifies the vehicle occupant P through the monitor 27 and the speaker 28 about the activation of the recommended function.

In step S223, the CPU 20A determines whether or not the vehicle occupant P has rejected the activation of the recommended function. Whether or not the vehicle occupant P rejects the activation may be determined through an utterance made by the vehicle occupant P, or through the vehicle occupant P operating the input switch 26. If the CPU 20A determines that the vehicle occupant P has rejected the activation of the recommended function (i.e., if the result of the determination in step S223 is YES), then the routine proceeds to step S225. If, on the other hand, the CPU 20A determines that the vehicle occupant P has not rejected the activation of the recommended function (i.e., if the result of the determination in step S223 is NO), then the routine proceeds to step S224.

In step S224, the CPU 20A executes the activation processing for the recommended function. In other words, the CPU 20A causes the vehicle on-board device 23 that pertains to the recommended function to perform the activation through the ECU 22 that pertains to the recommended function. The providing processing is then ended.

In step S225, the CPU 20A executes the suggestion processing for the recommended function. In other words, the CPU 20A suggests the activation of the recommended function to the vehicle occupant P through the monitor 27 and the speaker 28. The providing processing is then ended.

As a result, according to the providing processing of the present exemplary embodiment, by requesting permission to activate from the vehicle occupant P prior to activating a recommended function, it is possible to inhibit a function of the vehicle 12 that the vehicle occupant P does not wish to be activated from being activated due to the intention of the vehicle occupant P being wrongly identified by the intention identification portion 210, or to the vehicle occupant P subsequently changing their mind after their intention has been identified.

Remarks

In the above-described respective exemplary embodiments, the intention identification portion 210 identifies an intention of a vehicle occupant P based on utterances spoken by the vehicle occupant P, or on their facial expression or movements, however, the present disclosure is not limited to this. For example, it is also possible for the intention identification portion 210 to identify an intention of a vehicle occupant P based on operations performed by the vehicle occupant P on the monitor 27 if this is a touch panel. The operations in this case may be, for example, the vehicle occupant P inputting a text string into the monitor 27, or making a selection from a range of choices displayed thereon or the like.

Note that in the above-described exemplary embodiments, it is also possible for the various types of processing executed by the CPU 20A and the CPU 30A after reading software (i.e., programs) to instead be executed by various types of processors other than a CPU. Examples of other types of processors in this case include PLD (Programmable Logic Devices) whose circuit configuration can be altered after manufacturing such as an FPGA (Field-Programmable Gate Array), and dedicated electrical circuits and the like which are processors having a circuit configuration that is designed specifically in order to execute a particular processing such as ASIC (Application Specific Integrated Circuits). In addition, the above-described receiving processing may be executed by just one type from among these various types of processors, or by a combination of two or more processors that are either the same type or are mutually different types (for example by a plurality of FPGA or by a combination of a CPU and an FPGA). Furthermore, the hardware structures of these different types of processors are, more specifically, electrical circuits obtained by combining circuit elements such as semiconductor elements and the like.

Moreover, in the above-described exemplary embodiments, a mode in which each program is stored (i.e., installed) in advance on a computer-readable non-transitory recording medium is described. For example, the control program in the vehicle on-board unit 20 is stored in advance in the ROM 20B, and the processing program 100 in the central server 30 is stored in advance in the storage 30D. However, the present disclosure is not limited to this, and it is also possible for reach program to be provided in a mode in which it is recorded on a non-transitory recording medium such as a CD-ROM (Compact Disc Read Only Memory), a DVD-ROM (Digital Versatile Disc Read Only Memory), or a USB (Universal Serial Bus) memory. Moreover, it is also possible to employ a mode in which each program is downloaded from an external device through a network.

The processing in each of the above-described exemplary embodiments is not limited to being executed by a single processor, and may also be executed by a plurality of processors operating in mutual collaboration with each other. The flows of processing described in the above exemplary embodiments are also simply examples thereof, and steps considered superfluous may be deleted, or new steps added, or the processing sequence modified insofar as this does not cause a departure from the spirit or scope of the present disclosure.

Exemplary embodiments of the present disclosure have been described above, however, the present disclosure is not limited to these. Various modifications and the like may be made to the present disclosure insofar as they do not depart from the spirit or scope of the present disclosure.

What is claimed is:

1. An agent device, comprising a processor, wherein the processor is configured to:
receive words and actions from an occupant of a vehicle;
identify an intention of the received words and actions;
select, as a recommended function, a function of the vehicle that is recommended for activation based on the identified intention of the vehicle occupant;
decide which of activating the selected recommended function, or suggesting the activation thereof, to execute based on predetermined conditions pertaining to an environment of the vehicle; and
instruct the vehicle either to activate the recommended function or to suggest the activation thereof, based on which of these the processor has decided to execute.

2. The agent device according to claim 1, wherein the processor is further configured to:
receive information regarding acquired images of the vehicle occupant that are acquired by an image acquisition device installed in the vehicle; and
identify the intention of the vehicle occupant based on at least one of a facial expression or a movement of the vehicle occupant.

3. The agent device according to claim 1, wherein the processor is further configured to:
receive an action performed by the vehicle occupant at a display device that is installed in the vehicle; and
identify the intention of the vehicle occupant based on the action.

4. The agent device according to claim 1, wherein the processor is further configured to:
acquire weather information relating to weather in a geographical location at which the vehicle is traveling; and
decide which of activating the recommended function or suggesting the activation thereof, to execute, with a state of the weather shown by the acquired weather information set as a predetermined condition.

5. The agent device according to claim 4, wherein, in a case in which the recommended function is a function that is associated with the state of the weather, the processor decides that the recommended function is to be activated, and in a case in which the recommended function is a function that is not associated with the state of the weather, the processor decides that activation of the recommended function is to be suggested.

6. The agent device according to claim 1, wherein the processor is further configured to:
acquire position information for the vehicle; and
decide which of activating the recommended function or suggesting the activation thereof, to execute, with a position of the vehicle that corresponds to the acquired position information set as a predetermined condition.

7. The agent device according to claim 6, wherein, in a case in which the position is one at which the recommended function is able to be used, the processor decides that the recommended function is to be activated, and in a case in which the position is one at which the recommended function is not able to be used, the processor decides that activation of the recommended function is to be suggested.

8. The agent device according to claim 1, wherein the processor is further configured to:
acquire a travel state of the vehicle; and
decide which of activating the recommended function or suggesting the activation thereof, to execute, with the acquired travel state of the vehicle set as a predetermined condition.

9. The agent device according to claim 8, wherein, in a case in which the vehicle is stopped, the processor decides that the recommended function is to be activated, while in a case in which the vehicle is traveling, the processor decides that activation of the recommended function is to be suggested.

10. The agent device according to claim 1, wherein the processor is further configured to:
acquire a travel time of the vehicle; and
decide which of activating the recommended function or suggesting the activation thereof, to execute, with the acquired travel time of the vehicle set as a predetermined condition

11. The agent device according to claim 1, wherein the processor is further configured to:
acquire a brightness outside the vehicle; and
decide which of activating the recommended function or suggesting the activation thereof, to execute, with the acquired brightness outside the vehicle set as a predetermined condition.

12. An agent method, in which a computer executes processing comprising:
receiving words and actions from an occupant of a vehicle;
identifying an intention of the received words and actions;
selecting, as a recommended function, a function of the vehicle that is recommended for activation based on the identified intention of the vehicle occupant;
deciding which of activating the selected recommended function or suggesting the activation thereof, to execute based on predetermined conditions pertaining to an environment of the vehicle; and
instructing the vehicle either to activate the recommended function or to suggest the activation thereof, based on which of these the processor has decided to execute.

13. An agent program executable by a computer to perform processing, the processing comprising:
receiving words and actions from an occupant of a vehicle;
identifying an intention of the received words and actions;
selecting, as a recommended function, a function of the vehicle that is recommended for activation based on the identified intention of the vehicle occupant;
deciding which of activating the selected recommended function or suggesting the activation thereof, to execute based on predetermined conditions pertaining to an environment of the vehicle; and
instructing the vehicle either to activate the recommended function or to suggest the activation thereof, based on which of these the processor has decided to execute.
